(19) United States
(12) Patent Application Publication
(10) Pub. No.: US 2014/0293632 A1
(43) Pub. Date: Oct. 2, 2014

(54) ILLUMINATING DEVICE FOR MOTOR VEHICLE

(71) Applicant: NIHON PLAST CO., LTD., Shizuoka (JP)

(72) Inventor: Takeshi WATANABE, Shizuoka (JP)

(73) Assignee: NIHON PLAST CO., LTD., Shizuoka (JP)

(21) Appl. No.: 14/231,204

(22) Filed: Mar. 31, 2014

(30) Foreign Application Priority Data
Apr. 2, 2013 (JP) 2013-076869

(51) Int. Cl. B60Q 3/04

(52) U.S. Cl. CPC B60Q 3/04
USPC 362/511

(57) ABSTRACT

An illuminating device for motor vehicle including an upper panel and a lower panel, an illumination opening partitioned between the upper and lower panels, and an illuminating portion having a light source portion and a light guide body configured to guide light from the light source portion to the illumination opening. A protrusion portion is set on the lower panel. A recessed portion into which the protrusion portion is to be inserted and an opposite portion that opposed to the protrusion portion are provided on the upper panel. A shading portion, provided between the opposite portion and a the light guide body, is configured to lower luminance of the leak light from the light guide body towards an opposite side to the illumination opening.

### CROSS REFERENCE TO RELATED APPLICATIONS

This application claims priority of Japanese Patent Application No. 2013-076869 filed on Apr. 2, 2013. The contents of this application are incorporated herein by reference in their entirety.

### BACKGROUND OF THE INVENTION

1. Field of the Invention

The present invention relates to an illuminating device for motor vehicle, provided with an illuminating portion in which at least a light guide body is housed in a housing portion that is partitioned between first and second panels.

2. Description of the Related Art

Conventionally, it has been known that there is provided a construction in which its related decorativeness and visibility are improved by employing an illuminating device with respect to a glove box that is a housing device included in an instrument panel positioned at a front side of an occupant's seat of a vehicle that is a motor vehicle, for example. As an illuminating device, in recent years, there has been employed an indirect illuminating device that is provided with: a light source portion such as an LED; and a lens serving as a light guide body configured to guide light from this light source portion, so as to achieve indirect illumination with the light from the light source portion via the lens.

In the case of such a construction, the illuminating device is incorporated inside of the instrument panel. On the other hand, the instrument panel is constructed in such a manner that a variety of devices are disposed, whereby a plurality of panel members are combined with each other. Thus, there is a need to restrain unintended leak light from a gap between the panel members.

For example, it has been known that there is provided a construction in which the leak light in an unintended direction from a light source portion is restrained by providing an elastic member configured to close a gap between wall portions of a housing portion configured to house the light source portion, or alternatively, by providing a structure of surrounding the light source. (For example, reference should be made to Japanese Unexamined Utility Model Application Publication No, 61-16586 and Japanese Unexamined Patent Application Publication No. 2003-231444.)

However, in the case of the construction mentioned above, although it is considered to restrain a leakage of direct light from the light source portion; it is not considered to prevent a leakage of leak light to a rear face side of the lens or the like. Therefore, there has been a demand for a construction that is capable of restraining such a leakage of the leak light from the lens to the outside.

### SUMMARY OF THE INVENTION

The present invention has been made in view of the problem described above, and it is an object to provide a vehicle in such a manner as to enable the leak light from a light guide body to hardly leak from a gap between panel members to the outside.

An illuminating device for motor vehicle, according to a first aspect of the present invention, includes: first panel member that is provided with first engaging portion; second panel member that is provided with second engaging portion to be engagingly locked to such first engaging locking portion, and that covers a part of such first panel member; a housing portion that is partitioned between such first panel member and such second panel member; an illumination opening that is partitioned between such first panel member and such second panel member, and that communicates the housing portion and external; and an illuminating portion having a light source portion and a light guide body configured to guide light from the light source portion to the illumination opening, at least the light guide body being housed in the housing portion, wherein one of the first and second engaging portions is a protrusion portion, the other of the first and second engaging portions has a recessed portion into which the protrusion portion is to be inserted and an opposite portion that is opposed to the protrusion portion, and a shading portion configured to lower luminance of the leak light from the light guide body towards an opposite side to the illumination opening is set at a position between the opposite portion and the light guide body.

An illuminating device for motor vehicle, according to a second aspect of the present invention, is provided in such a manner that, in the illuminating device for motor vehicle, according to the first aspect, at least part of the shading portion is a coupling assembly configured by a plurality of plane portions respectively having different angles. Further, according to other aspect of the present invention, in the illuminating device for motor vehicle, according to the first aspect, at least part of the shading portion is formed in the shape of a polygonal line in a state in which a plurality of linear portions respectively having different angles are combined with each other.

An illuminating device for motor vehicle, according to a third aspect of the present invention, is provided in such a manner that, in the illuminating device for motor vehicle, according to the first aspect, at least a part of the shading portion is formed in a nonlinear shape.

With the illuminating device for motor vehicle, according to the first aspect of the present invention, either one of first engaging portion of first panel member and second engaging portion that is positioned on one side of second and member is formed as a protrusion portion; a recessed portion into which the protrusion portion is to be inserted and an opposite portion that is opposed to the protrusion portion are set at the other one, and a shading portion is provided at a position between the opposite portion and a light guide body, whereby, at a position of the recessed portion with Which the protrusion portion engages, it is possible to cause the leak light from the light guide body to hardly leak from a gap between such first and second panel members to the outside by means of the engagement of these recessed and protrusion portions; and at a position of an opposite portion which does not engage with the protrusion portion, the luminance of the leak light from the light guide body towards an opposite side to an illumination opening is lowered by means of the shading portion, thereby enabling the leak light from the light guide body to hardly leak from the gap between such first and second panel members to the outside.

With the illuminating device for motor vehicle, according to the second aspect of the present invention, in addition to the advantageous effect of the illuminating device for motor vehicle, according to the first aspect, at least one of the shading portion is a coupling assembly configured by a plurality of plane portions respectively having different angles. In other words, at least a part of the shading portion is formed in the shape of a polygonal line in a state in which linear portions, a respective one of which has a different angle, are combined with each other, whereby the leak light from a light guide body towards an opposite side to an illumination opening is reflected and refracted in a complicated manner, the luminance of the leak light can be reliably lowered, enabling the leak light from the light guide portion to more hardly leak from a gap between first and second panel members to the outside and enabling a shading portion to be easily formed.

With the illuminating device for motor vehicle, according to the third aspect of the present invention, in addition to the advantageous effect of the illuminating device for motor vehicle, according to the first aspect, at least a part of the shading portion is formed in a nonlinear shape, whereby the leak light from a light guide body towards an opposite side to an illumination opening is reflected and refracted in a complicated manner, the luminance of the leak light can be more reliably lowered, enabling the leak light from the light guide portion to more hardly leak from a gap between first and second panel members to the outside.

### BRIEF DESCRIPTION OF THE DRAWINGS

FIG. 1A and FIG. 1B are sectional views each showing one embodiment of an illuminating device for motor vehicle, according to the present invention, wherein FIG. 1A shows a position that is opposed to an opposite portion, and FIG. 1B shows a position that corresponds to a recessed portion;

FIG. 2 is a sectional view showing an equivalent position taken along the line I-I of FIG. 1B;

FIG. 3 is a perspective view showing a shading portion taken along the same line;

FIG. 4 is a plan view showing a top panel portion;

FIG. 5 is a perspective view showing a part of an instrument panel that is provided with the illuminating device for motor vehicle; and

FIG. 6 is a plan view schematically showing a shading portion according to another embodiment of the present invention.

### DESCRIPTION OF THE PREFERRED EMBODIMENTS

Hereinafter, one embodiment of an illuminating device for motor vehicle, according to the present invention, will be described with reference to the accompanying drawings.

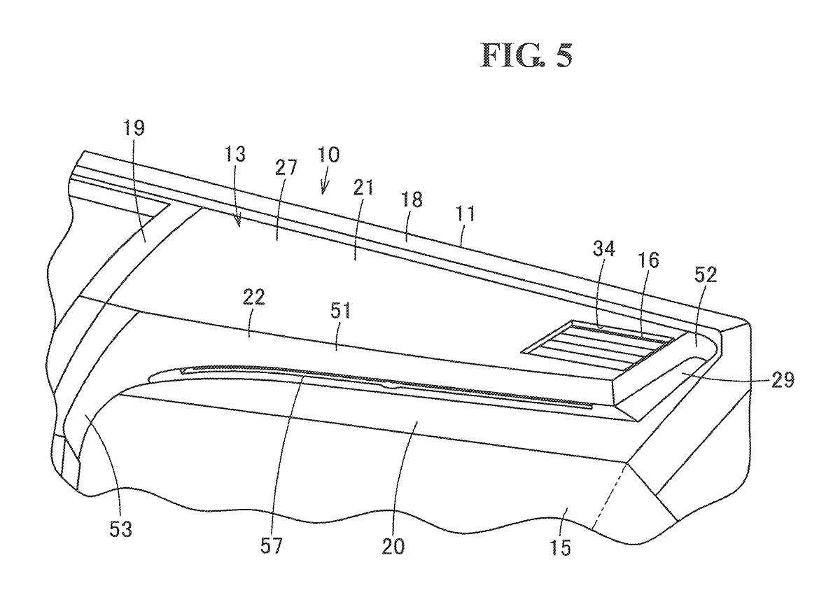

In FIG. 5, reference numeral 10 designates an instrument panel serving as a mounted portion, and this instrument panel 10 is an automobile component that is an interior member positioned in front of a front seat in a vehicle room of an automobile that is a vehicle serving as a motor vehicle, and that is mounted to a vehicle body in opposite to an occupant at the front seat. In addition, this instrument panel 10 is provided with: an instrument panel frame portion 11 serving as a main body of the mounted portion; a meter device that is mounted to this instrument panel frame portion 11; panel portion 13; and a center console, although not shown, and a glove box 15 serving as a housing device is positioned and disposed at a lower side of the panel portion 13. Further, in this instrument panel 10, a ventilator 16 or the like is mounted to the panel portion 13 so as to configure an instrument panel device. Hereinafter, directions such as a vertical direction and a lateral direction will be described with a direction of an automobile cruising forward being defined as a reference. In addition, it is to be noted that in this description, as seen from an occupant, a front side of the occupant is defined as a front face side, and an opposite side of the occupant, that is, a front side of a vehicle body is defined as a rear face side.

In addition, the instrument panel frame portion 11 is provided with: a meter mounting portion serving as a part mounting portion that is positioned in front of a driver's seat, although not shown; a mounting portion 18 that is positioned in front of an occupant seat; and a console mounting portion 19 that is positioned between the meter mounting portion (the driver's seat) and panel mounting portion 18 mentioned above (the occupant seat), and that extends in a vertical direction so as to be formed in an elongated shape in a lateral direction.

The meter mounting portion is formed in the shape of an elongated flat ring in the lateral direction as seen from an occupant and protrudes more upward than the panel mounting portion 18 and the console mounting portion, and inside of the meter mounting portion, a meter device is mounted by means of engagement and screw tightening or the like.

The panel mounting portion 18 is formed in the shape of the elongated flat ring in the both sides direction as seen from the occupant, and inside of the panel mounting portion, the panel portion 13 is mounted by means of engagement and screw tightening or the like. In addition, a glove box 15 is mounted on one side of the console mounting portion 19 at a lower part of this panel mounting portion 18. Further, an extension portion 20 that extends in an inclined manner to a lower back side is formed at a lower edge part of this panel mounting portion 18. This extension portion 20 extends in a lateral direction along an upper part of the glove box 15.

The console mounting portion 19 is formed in the shape of an elongated ring in a vertical direction as seen from the occupant, and inside of the console mounting portion, a center console is mounted by means of engagement and screw tightening or the like.

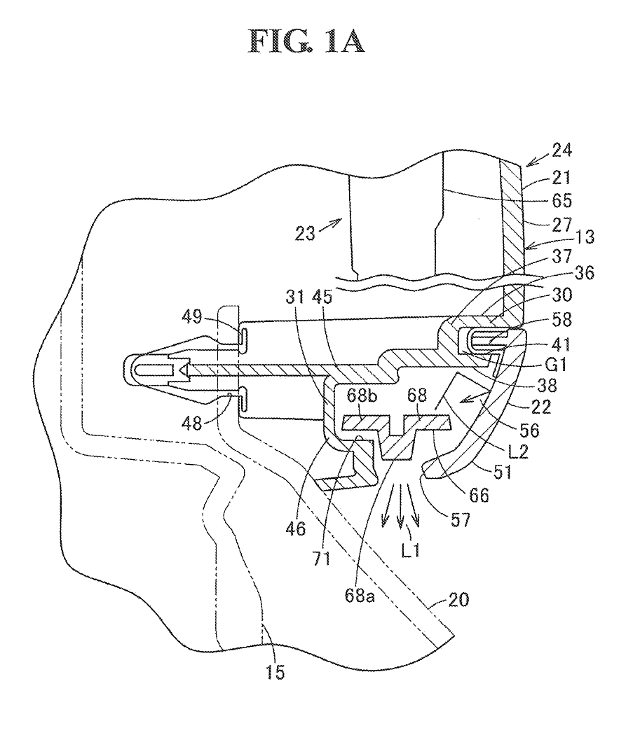

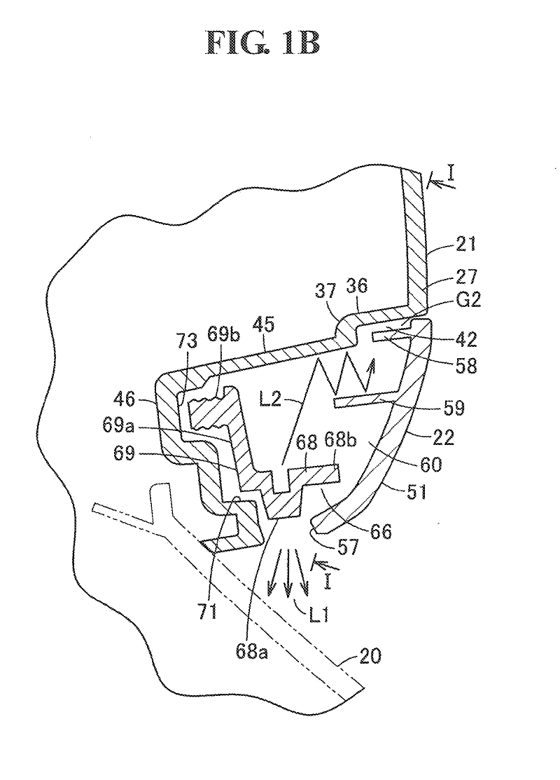

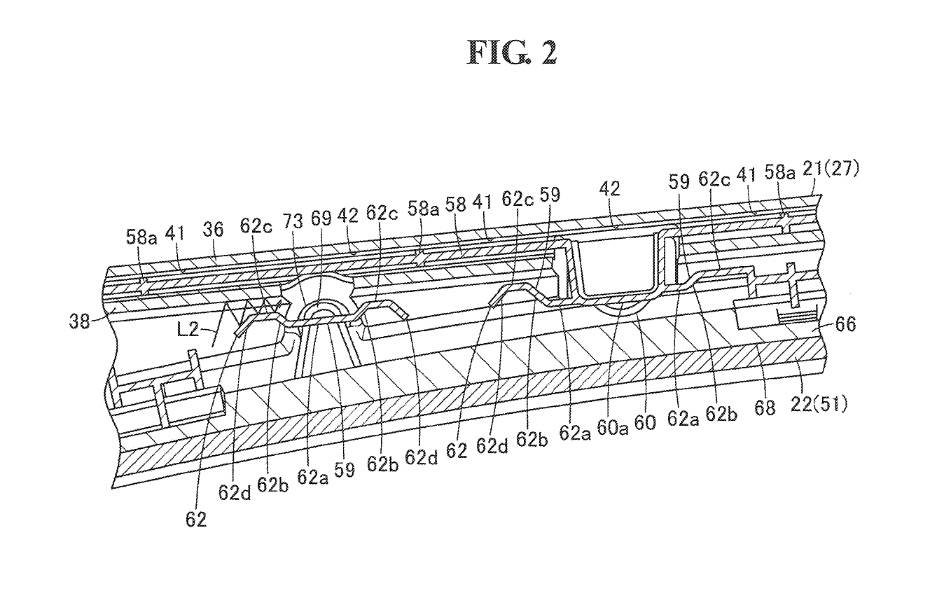

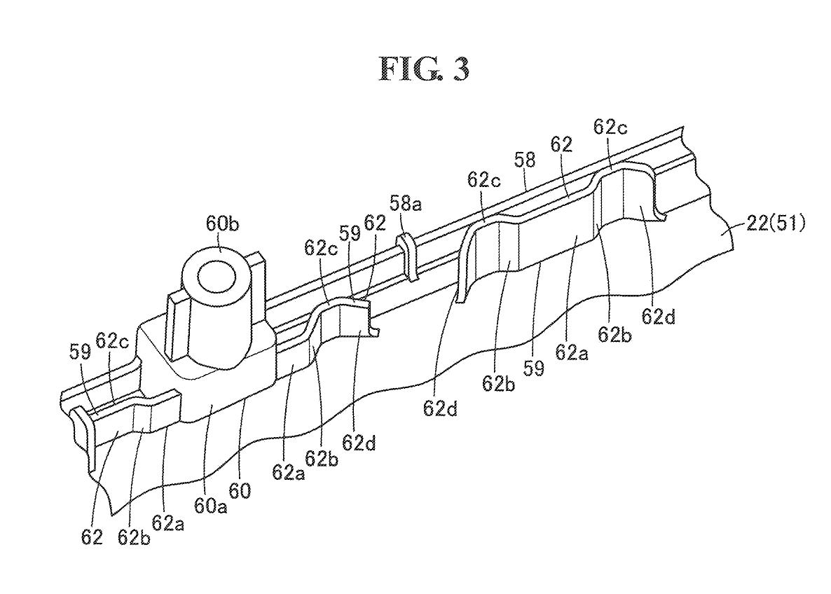

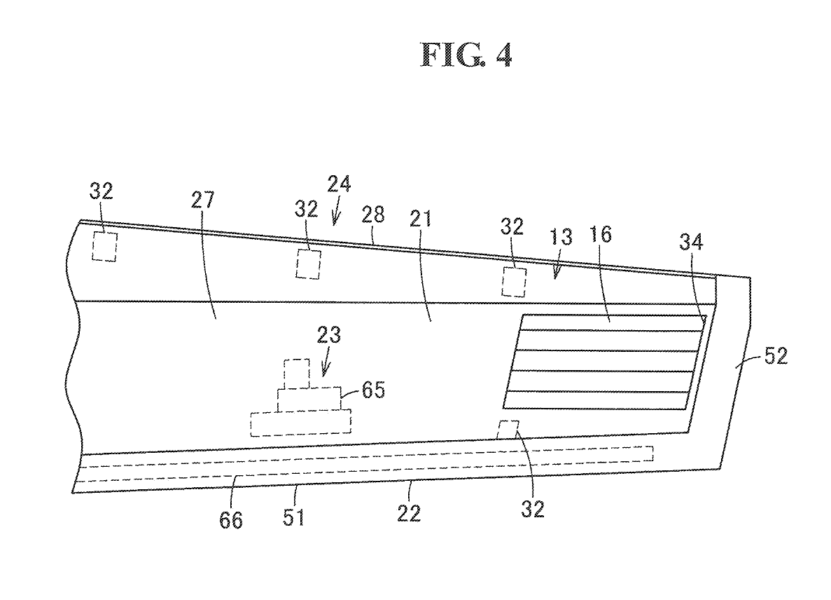

In addition, as shown in FIG. 1 to FIG. 5, the panel portion 13 is disposed so as to opposed to an occupant at an occupant seat, and is constructed by combining an upper panel 21 serving as first panel member and a lower panel 22 serving as second panel member. Further; inside of this panel portion 13, an illuminating portion 23 is mounted, and an indirect illuminating device 24 (for motor vehicle) serving as an illuminating device for motor vehicle (illuminating device for vehicle) is configured with the panel portion 13 and the illuminating portion 23 mentioned above.

The upper panel 21 configures a panel main body of the instrument panel 10, is integrally molded with a member such as a synthetic resin, for example, and is provided with: an upper panel main body 27 serving as first panel member main body that has a longitudinal direction along a lateral direction, i.e., that is formed in an elongated shape; a top plate portion 28 that is positioned along an upper edge that is one side of this upper panel main body 27; an end plate portion 29 that is positioned along one end of this upper panel main body 27; a lower engaging portion 30 serving as first engaging portion that is positioned along a lower edge that is the other end of the upper panel main body 27; and a partitioning portion 31 that is continuous to this lower engaging portion 30. In addition, on a front face side that is a rear face side of this upper panel 21, a plurality of mounting portions 32 is provided for mounting the panel portion 13 (the upper panel 21) to the panel mounting portion 18 or the like by means of screw tightening or the like.

In the upper panel main body 27, at a position that is proximal to one end of the main body, a ventilator mounting portion 34 that is an opening formed in a rectangular shape is formed, and inside of this ventilator mounting portion 34, a ventilator 16 is mounted by means of engagement and screw tightening or the like.

The top plate portion 28 and the end plate portion 29 each protrude from the upper panel main body 27 to a front side, and a front end side that is a tip end side is inserted into an upper edge and one end edge of the panel mounting portion 18 and is continuous to the upper edge and such one end edge mentioned above. In addition, one end of the top plate portion 28 and an upper end of the end plate portion 29 are continuous to each other.

The lower engaging portion 30 integrally has: an upper wall portion 36 that protrudes from a lower edge of the upper panel main body 27 to a front side; a front wall portion 37 that protrudes from a front end of this upper wall portion 36 to a lower side; and lower wall portions 38 that are protruded rearward at a plurality of sites in a lateral direction on a lower edge of this front wall portion 37. In addition, an upper part, a front part, and a lower part are surrounded by the upper wall portion 36, the front wall portion 37, and the lower wall portion 38, whereby a recessed portion 41 is formed, and by means of the upper wall portion 36 and the front wall portion 37, an opposite portion 42 having an opened lower part is formed. That is, the lower engaging portion 30 is configured with a plurality of recessed portions 41 and a plurality of opposite portions 42 excluding the above mentioned recessed portions 41 in a lateral direction. Therefore, each of the recessed portions 41 is recessed in a forward direction, and is formed in a grooved shape that extends in an elongated shape along a lateral direction.

The partitioning portion 31 integrally has: a partitioning upper wall portion 45 serving as a reflecting wall portion that extends from a lower end part of the front wall portion 37 of the lower engaging portion 30, that is, from a front end part of a respective one of the recessed portion 41 and the opposite portion 42, to a front side that is an opposite side to the lower panel 22 (the lower wall portion 38); and a partitioning front wall portion 46 serving as an opposite wall portion that protrudes from a front end of this partitioning upper wall portion 45 to a lower side. That is, this partitioning portion 31 is bent in a substantial L-shape as seen in a side view. Further, a lower end part of this partitioning front wall portion 46 comes into intimate contact with the extension portion 20 or extends up to the proximity of the extension portion 20. In addition, on a front side that is a rear face side of this partitioning portion 31, engaging protrusion portions 49, each of which is configured to insert and engagingly lock the upper panel 21 with respect to a lower edge of the panel mounting portion 18, that is, with respect to an engaging opening portion 48 that is provided at an upper end part of the extension portion 20, are respectively protruded toward a front side at a plurality of sites in a lateral direction. It is to be noted that at positions which correspond to the engaging protrusion portions 49 mentioned above, a lower wall portion 38 of the lower engaging portion 30 is not provided. Therefore, the opposite portions 42 are disposed so as to correspond to positions of the engaging protrusion portions 49, that is, positions for mounting the upper panel 21 to the instrument panel frame portion 11, and the recessed portion 41 and the opposite portions 42 are respectively provided alternately intermittently in a lateral direction.

On the other hand, the lower panel 22 covers a lower edge part and one end part of the upper panel 21 in an L-shape, is disposed along a boundary position between the instrument panel 10 and the glove box 15, and is integrally molded with a member such as a synthetic resin, for example. Also, this lower panel is provided with: a lower panel main body 51 having a longitudinal direction along a both sides direction, that is, serving as another elongated another panel member main body; an upper end plate portion 52 that extends from one end of this lower panel main body 51 to an upper side; and a lower end plate portion 53 that extends from the other end of the lower panel main body 51 to a lower side. Therefore, this lower panel 22 is formed so as to be bent in a crank shape.

The lower panel main body 51, as seen in a side view, is formed in a plate shape that is curved gradually forward from an upper side to a lower side. This lower panel main body 51 is opposed to a respective one of the lower engaging portion 30 (the recessed portion 41 and the opposite portion 42) and the partitioning portion 31, and covers the entirety of a rear side of the lower engaging portion 30 and the partitioning portion 31 mentioned above. In addition, this main body partitions a housing portion 56 between the main body and the upper panel 21, and partitions an illumination opening 57 that communicates with the housing portion 56 and an external part (the inside of the vehicle room) between a lower end that is the other side and a lower end of the partitioning portion 31 (the partitioning front wall portion 46). That is, the illumination opening 57 is positioned at a lower end of the housing portion 56. In addition, on a front side that is a rear face side of this lower panel main body 51, a protrusion portion 58 that is positioned on an upper side that is one side, and that is also an upper engaging portion serving as second engaging portion, is protruded in a rib shape toward the lower engaging portion 30 (the recessed portion 41 and the opposite portion 42), that is, toward a front side; and at a plurality of sites on a lower side of this protrusion portion 58, shading portions 59 are protruded in a rib shape to the inside of the housing portion 56 and to the front side and a fixing portion 60 for fixing the lower panel 22 (the lower panel main body 51) to the upper pane 21 is protruded to a front side. That is, the protrusion portion 58, the shading portion 59, and the fixing portion 60 mentioned above are respectively formed along a forward and backward direction that is a die opening direction of a molding die at the time of insert molding of the lower panel 22.

The housing portion 56 houses a part of the illuminating portion 23 to be described later, and is partitioned in an elongated shape in a both sides direction.

The illumination opening 57 is formed in an elongated shape in a both sides direction and is formed in a slit shape in which a dimension in a forward and backward direction is smaller than a dimension in the both sides direction, and is positioned at an upper side of the extension portion 20. That is, this illumination opening 57 is seen (opposed) to the extension portion 20, and is opened to a lower side.

The protrusion portion 58 continuously extends in an elongated shape along a both sides direction, inserted into each of the recessed portions 41 from a rear side; achieves a so called pillbox fitting in such a manner that the lower wall portion 38, the protrusion portion 58, and the upper wall portion 36 are alternately positioned in a wall shape; and is opposed to a rear part of each of the opposite portions 42. Also, by means of the engagement between the protrusion portion 58 and each of the recessed portions 41, it is possible to assure an alignment quality of a gap or a shift exerted by a dimensional distortion in dimensional tolerance between the upper panel 21 and the lower panel 22. In addition, in this protrusion portion 58, a reinforcing ribs 58a, each of which serves as a reinforcing portion for reinforcement, are respectively provided at a plurality of sites in a lateral direction, along a vertical direction crossing (orthogonal to) this protrusion portion 58. It is to be noted that this protrusion portion 58 is continuous to a both sides of this fixing portion 60 at a position that corresponds to the fixing portion 60. That is, the protrusion portion 58 is disposed at a position excluding the fixing portion 60. In addition, this protrusion portion 58 may be continuous across the upper end plate portion 52 or the lower end plate portion 53, for example.

The shading portions 59 each are disposed at least at a position that corresponds to the opposite portion 42 at a position that is spaced from the protrusion portion 58 to a lower side. That is, the shading portions 59 mentioned above are intermittently disposed in a lateral direction. The shading portions 59 are a coupling assembly configured by a plurality of plane portions respectively having different angles. In other words, the shading portions 59 mentioned above are respectively formed in the shape of a polygonal line by a plurality of tinier portions 62, a respective one of which has a different angle. For example, this linear portion 62, in a substantial M-shape as seen from a front side, is configured with: (one) parallel linear portion 62a that is substantially parallel to the protrusion portion 58 in such a manner that a rear end side that is a proximal end side is positioned at a lower side of the opposite portion 42 that is a position corresponding to the opposite portion 42, a front end side that is a tip end side is opposed to the partitioning upper wall portion 45, and is substantially parallel to the protrusion portion 58, that is, the parallel linear portion extending in an elongated shape in a lateral side; (one) inclined linear portion 62b that is continuous to a side part of this parallel linear portion 62a, and that is inclined in a direction approaching to the protrusion portion 58, for example, on the order of 45 degrees; (another) parallel linear portion 62c that is continuous to a side part of this inclined linear portion 62b, that is, the inclined linear portion extending in an elongated shape in a lateral direction; and (another) inclined linear portion 62d that is continuous to a side part of this parallel linear portion 62c, and that is inclined in a direction spaced from the protrusion portion 58, for example, on the order of 45 degrees. That is, this shading portion 59 is set so that a gap relevant to the protrusion portion 58 is gradually decreased on the side of the opposite portion 42 (on the side of the parallel linear portion 62a) by means of the inclined linear portion 62b and then is gradually increased by means of the inclined linear portion 62d. In other words, this shading portion 59 is formed so that a gap relevant to the protrusion portion 58 increases or decreases (changes) on the side of the opposite portion 42, that is, so that the gap relevant to the protrusion portion 58 is not uniform. It is to be noted that as far as the shading portion 59 is concerned, at a position that corresponds to the fixing portion 60, the parallel linear portion 62a is continuous to a side part of the fixing portion 60.

The fixing portion 60 is provided with: a fixing base portion 60a that is provided in a box shape of which an upper side is opened with respect to a front face of the lower panel main body 51; and a boss portion 60b that protrudes from this fixing base portion 60a to a front side. The fixing base portion 60a is continuous to the protrusion portion 58 and the shading portion 59 (the parallel linear portion 62a) on both sides. In addition, this fixing portion 60 is disposed at a position that corresponds to the opposite portion 42, engages with the opposite portion 42 at the time of mounting the lower panel 22 to the upper panel 21, and positions the lower panel 22 in a lateral direction and a vertical direction with respect to the upper panel 21, and a front end part that is a tip end part of the boss portion 60b is inserted into a hole portion, although not shown, the hole portion being opened in the upper panel 21 (the partitioning portion 31 (partitioning front wall portion 46), and by inserting and tightening a screw or the like, although not shown, from a front side of the partitioning portion 31 of the upper panel 21 (a front side of the panel mounting portion 18 of the instrument panel frame portion 11), the lower panel 22 can be securely screwed with respect to the upper panel 21 or the panel mounting portion 18 of the instrument panel frame portion 11 together with the upper panel 21.

The upper end plate portion 52 extends while covering a portion at which one end of the upper panel main body 27 of the upper panel 21 and one end of the top plate portion 28 and the end plate portion 29 are continuous to each other.

The lower end plate portion 53 protrudes from the lower part of the upper panel 21 to a lower side, and extends along a side part of the console mounting portion 19.

The illuminating portion 23 is provided with: a light source unit 65 serving as a light source portion; and a lens 66 serving as a light guide body.

The light source unit 65 is provided with a light emitting element such as an LED and a supporting body or the like for supporting this light emitting element, for example, in a united manner, and power is supplied from a power source portion for motor vehicle (vehicle), although not shown. In addition, this light source unit 65 is housed in a substantial center part in a lateral direction of the upper panel main body 27 of the upper panel 21 and in a frontal position of this upper panel 21, and is disposed so that light is caused to be incident to the lens 66.

The lens 66 is integrally molded with a member such as a synthetic resin having a transparency, for example, and is provided with: a lens main body portion 68 serving as a light guide body main body portion that is formed in an elongated manner along a lateral direction; and lens engaging portions 69 serving as light guide body engaging portions that are provided at a plurality of sites at a front end of this lens main body portion 68. Also, this lens is housed along the inside of the housing portion 56. It is to be noted that this lens 66 may be provided solely or in plurality as long as it is disposed all over the illumination opening 57.

The lens main body portion 68 integrally has: an illumination main body portion 68a that is opposed to an upper side of the illumination opening 57, and that is gradually decreased in width in a forward and backward direction to this illumination opening 57, the illumination main body portion 68a has a section substantially trapezoidal shape, and a supported portion 68b that protrudes from an upper end part of this illumination main body portion 68a along the forward and backward direction. In addition, a lower part on a front end side of this supported portion 68b is supported at the partitioning portion 31 of the upper panel 21 by means of a support receiving portion 71 that is provided in proximity to a lower end of the partitioning front wall portion 46.

The lens engaging portion 69 integrally has: an engaging portion main body 69a that is protruded from the front end part of the supported portion 68b of the lens main body portion 68 to an upper side; and an inserting portion 69b that is protruded to a front side at an upper end side that is a tip end side of this engaging portion main body 69a. In addition, this inserting portion 69b is inserted into, and is engagingly locked to, an engaging recessed portion 73 that is recessed in the partitioning front wall portion 46 in the partitioning portion 31 of the upper panel 21, whereby the lens 66 is positioned in a lateral direction and a vertical direction with respect to the upper panel 21 (and the lower panel 22).

The glove box 15 is formed in a box shape in which an upper part opens, and is pivoted at a lateral position so as to be rotatable in a forward and backward direction. In addition, this glove box 15 is engagingly locked and retained via a clamp, although not shown, with respect to the instrument panel 10 in a state in which the glove box turns forward, and by releasing this engaging and retention and then turning to a rear side (the occupant side), an upper opening is seen on the occupant side.

Further, when the indirect illuminating device 24 is assembled, a light source unit 65 that is disposed in the instrument panel frame portion 11 is covered, the upper panel 21 that is molded in advance is mounted to the panel mounting portion 18 of the instrument panel frame portion 11, and an inserting portion 69b of the lens engaging portion 69 of the lens 66 is inserted into an engaging recessed portion 73 of this upper panel 21 and then the lens 66 is fixed to the upper panel 21.

In this state, a part of the lens 66 is opposed to the light source unit 65, enabling the light from the light source unit 65 to be incident to the lens 66.

Next, the lower panel 22 that is molded in advance is mounted to the upper panel 21 in a state in which the lens 66 is covered with the panels mentioned above. At this time, in the lower panel 22, while the protrusion portion 58 or the like is defined as a front side, a front end side of the boss portion 60b of the fixing portion 60 is inserted into a hole portion between the recessed portions 41 of the upper panel 21, and the protrusion portion 58 is inserted into the recessed portion 41 and then a screw or the like, although not shown, is inserted into the boss portion 60b of the fixing portion 60 from a front side of the partitioning portion 31 of the upper panel 21 (a front side of the panel mounting portion 18 of the instrument panel frame portion 11), whereby the lower panel 22 is securely screwed with respect to the upper panel 21 or the panel mounting portion 18 of the instrument panel frame portion 11 together with the upper panel 21.

In this state, the lens 66 is housed in the housing portion 56 between the upper panel 21 and the lower panel 22, and is positioned at an upper side of the illumination opening 57 between the upper panel 21 and a lower part of the lower panel 22. In addition, a position between a lower part of the upper panel main body 27 of the upper panel 21 and an upper part of the lower panel main body 51 of the lower panel 22 serves as a part dividing portion (a parting portion) that communicates with a gap G1 (FIG. 1A) between the recessed portion 41 and the protrusion portion 58 and a gap G2 (FIG. 1B) between the opposite portion 42 and the protrusion portion 58. Further, inside of the housing portion 56, the shading portion 59 is intervened at a position between the lens 66 and the opposite portion 42, that is, at a position that is on a rear side of the lens 66 and at a lower position of the opposite portion 42.

In addition, this indirect illuminating device 24 guides the light from the light source unit 65 in a lateral direction by means of the lens 66, and achieves illumination (with main light L1) from a lower part of the illumination main body portion 68a of the lens main body 68 on the side of the glove box 15 (on the side of the extension portion 20) that is a lower side via the illumination opening 57, thereby improving decorativeness and improving visibility of the inside at the time of opening of the glove box 15.

At this time, in the lens 66, at the illumination main body portion 68a, leak light L2 slightly leaks at an upper side that is an opposite side to the illumination opening 57. As far as this leak light L2 is concerned, at a position of the recessed portion 41 on an upper side of the housing portion 56, the protrusion portion 58 achieves the pillbox engagement with this recessed portion 41, thereby providing a labyrinth structure in which the gap G1 between the upper panel 21 and the lower panel 22 is alternately bent in a forward and backward direction and thus light is reflected and refracted and then is scattered in this gap G1 (in other words, its related luminance is lowered), and the leak light to the occupant side does not leak (or hardly leaks). That is, at a position that is corresponds to this recessed portion 41, the leak light L2 is shaded by means of the lower wall portion 38 that forms the recessed portion 41, thus causing the leak light to hardly enter the gap G1, and in addition to this, the gap G1 itself is formed in a complicated shape, whereby the leak light L2 does not leak (or hardly leaks) from the gap G1 to the occupant side.

On the other hand, at a position proximal to the opposite portion 42 on an upper side of the housing portion 56, a cycle of reflection and refraction is repeated in a lateral direction between a respective one of the inclined linear portion 62a, the parallel linear portion 62c, and the inclined linear portion 62b of the shading portion 59 and a respective one of the protrusion portion 58 and the partitioning upper wall portion 45, and a cycle reflection and refraction is repeated in a forward and backward direction between the parallel linear portion 62a and the partitioning upper wall portion 45, whereby the leak light L2 is scattered (in other words, its related luminance is lowered), and does not leak (or hardly leaks) from the gap G2 between the upper panel 21 and the lower panel 22 to the occupant side. That is, at a position that corresponds to this opposite portion 42, although the gap G2 itself is formed in a comparatively simple shape, a path of the leak light L2 before reaching this gap G2 is formed in a complicated shape by means of the shading portion 59, and a distance leading up to the opposite portion 42 increases, whereby the leak light L2 does not leak (or hardly leaks) from the gap G2 to the occupant side.

In this manner; according to the embodiment, the protrusion portion 58 is provided on an upper side that is one side of the lower panel 22; the recessed portion 41 into which the protrusion portion 58 is to be inserted and the opposite portion 42 that is opposed to the protrusion portion 58 are set at the lower engaging portion 30 of the upper panel 21; and the shading portion 59 is provided at a position between the opposite portion 42 and the lens 66 of the illuminating portion 23, whereby at a position of the recessed portion 41 with which the protrusion portion 58 engages, by means of the engagement between these recessed and protrusion portions (the pillbox engagement), it is possible to cause the leak light L2 from the lens 66 to hardly leak from the gap G1 between the panels 21 and 22 to the outside, and at a position of the opposite portion 42 which does not engage with the protrusion portion 58, the leak light L2 from the lens 66 to the opposite side (the upper side) to the illumination opening 57 is reflected or refracted by means of the shading portion 59, and a distance leading up to the opposite portion 42 increases, whereby its related luminance is lowered, enabling the leak light L2 from the lens 66 to hardly leak from the gap G2 between the panels 21 and 22.

As a result, an indirect illuminating device 24 is provided in such a manner that the leak light from a gap between the panels 21 and 22 does not exist (decreases) and thus the quality of the indirect illuminating device 24 and the instrument panel 10 or the like employing this indirect illuminating device 24 can be improved. Also, the shading portion 59 is integrally protruded with the lower panel 22 and thus there is no need to set any additional component. Therefore, its related component costs can be reduced. In addition, there is no need to carry out a work of assembling such an additional part, and its related manufacturing costs can also be reduced. Moreover, even if the opposite portion 42 is positioned in a state in which the pillbox engagement between the recessed portion 41 and the protrusion portion 58 cannot be set from the viewpoint of design or vehicle layout, an appropriate countermeasure against the leak light from the gap G2 can be taken and thus a degree of freedom of a design (a design flexibility) can be expanded, and an occurrence of a failure at the time of mass-production can also be prevented.

In addition, the shading portion 59 is a coupling assembly configured by a plurality of plane portions respectively having different angles. In other words, the shading portion 59 is respectively formed in the shape of a polygonal line by means of a plurality of linear portions 62, a respective one of which has a different angle, whereby a distance leading up to the opposite portion 42 of the leak light L2 from the lens 66 to the opposite side (the upper side) to the illumination opening 57 is reliably increased, and the leak light L2 is reflected and refracted in a complicated manner, whereby the luminance of the leak light L2 can be reliably lowered, enabling the leak light L2 from the lens 66 to more hardly leak from the gap G2 between the panels 21 and 22 to the outside. Moreover, the shading portion 59 is formed in the shape of a polygonal line by means of the linear portions 62 and thus the shading portion can be easily formed in the lower panel 22.

Further, the shading portion 59 is formed along a die opening direction of a molding die at the time of insert molding of the lower panel 22 and thus there is no need to additionally set a movable frame such as a slide core to the molding die, and its related manufacturing costs of the molding die can be reduced as well.

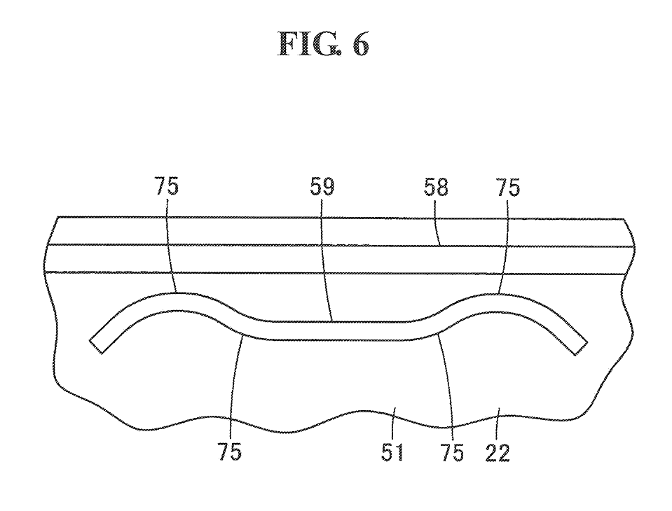

It is to be noted that in one of the embodiments described previously, as is the case with another embodiment shown in FIG. 6, at least a part of the shading portion 59 may be formed in a non-linear shape. That is, a curved portion 75 obtained by curving the shading portion 59 in a curved shape such as an arc shape may be formed as at least a part of the shading portion. In this case, a distance leading up to the opposite portion 42 of the leak light L2 from the lens 66 to the opposite side (the upper side) to the illumination opening 57 reliably increases, and the leak light L2 is reflected and refracted in a complicated manner, whereby the luminance of the leak light L2 can be reliably lowered, enabling the leak light L2 from the lens 66 to more hardly leak from the gap G2 between the panels 21 and 22 to the outside.

Further, in a state in which the embodiments described previously are combined with each other; the shading portion 59 may be formed in a shape having a portion of a polygonal line shape and a portion of a non-linear shape.

In addition, in each of the embodiments described previously, the recessed portion 41 and the opposite portion 42 may be set on the side of the lower panel 22, and the protrusion portion 58 may be set on the side of the upper panel 21. In this case, the partitioning upper wall portion 45 is protruded from the front end of the protrusion portion 58 to a front side, whereby there can be attained its related functions and advantageous effects which are similar to those of each of the embodiments described previously.

Further, the shading portion 59 may be provided on the side of the upper panel 21, for example, or alternatively, may be provided at a respective one of the side of the upper panel 21 and the side of the lower panel 22.

Furthermore, the indirect illuminating device 24 is not only employed for the instrument panel 10, but can also be applied to any interior member or an exterior member made of a plurality of panel members that are included in a vehicle room such as an automobile, the panel members being positioned in proximity to a site targeted to be illuminated.

Moreover, the indirect illuminating device 24 can be applied to any motor vehicle without being ‘imitative to a vehicle such as an automobile.

### INDUSTRIAL APPLICABILITY

The present invention can be preferably employed as an indirect illuminating device that improves decorativeness of a vehicle such as an automobile, for example.

What is claimed is:

1. An illuminating device for motor vehicle, comprising:
first panel member that is provided with first engaging portion;
second panel member that is provided with second engaging portion to be engaged to the first engaging portion, and that covers a part of the first panel member;
a housing portion that is partitioned between the first and second panel member;
an illumination opening that is partitioned between the first panel member and other end of the second panel member, and that communicates the housing portion and external; and
an illuminating portion having a light source portion and a light guide body configured to guide light from the light source portion to the illumination opening, at least the light guide body being housed in the housing portion,
wherein one of the first and second engaging portions is a protrusion portion,
the other the first and second engaging portions has a recessed portion into which the protrusion portion is to be inserted and an opposite portion that is opposed to the protrusion portion, and
a shading portion configured to lower luminance of leak light from the light guide body towards an opposite side to the illumination opening is set at a position between the opposite portion and the light guide body.

2. The illuminating device for motor vehicle, according to claim 1,
wherein at least part of the shading portion is a coupling assembly configured by a plurality of plane portions respectively having different angles.

3. The illuminating device for motor vehicle, according to claim 1,
wherein at least part of the shading portion is formed in a shape of a polygonal line in s state in which a plurality of linear portions respectively having different angles are combined with each other.

4. The illuminating device for motor vehicle, according to claim 1,
wherein at least a part of the shading portion is formed in a non-linear shape.
